(19) United States
(12) Patent Application Publication
(10) Pub. No.: US 2024/0240959 A1
(43) Pub. Date: Jul. 18, 2024

(54) Navigation Route Sharing

(71) Applicant: Google LLC, Mountain View, CA (US)

(72) Inventor: Matthew Sharifi, Kilchberg (CH)

(21) Appl. No.: 18/010,160

(22) PCT Filed: Sep. 29, 2021
(86) PCT No.: PCT/US2021/052630

§ 371 Date: Dec. 13, 2022

(51) Int. Cl. G01C 21/36

(52) U.S. Cl. CPC G01C 21/362

(57) ABSTRACT

Methods, systems, devices, and tangible computer readable media for navigation are provided. The disclosed technology can include receiving a navigation request from a user. There is a determination of whether the navigation request is associated with a user contact of the user. In response to the navigation request being associated with the user contact, a location sharing request can be generated. The location sharing request includes a request for location data including information associated with locations associated with the user contact. The location sharing request can be sent to a remote computing system associated with the user contact. Furthermore, in response to receiving the location data from the remote computing system, output can be generated. The output can include indications associated with navigation by the user to at least one of the locations associated with the user contact.

### FIELD

The present disclosure relates generally to the generation of routes for navigation. More particularly, the present disclosure relates to generating routes and directions based on shared navigational information.

### BACKGROUND

Operations associated with navigation can be implemented on a variety of computing devices. These operations can include processing data associated with requests from one user to another user for assistance in navigating to some geographic location. Further, the operations can include exchanging data with remote computing systems that can provide directions for navigation to various locations within the geographic areas being navigated. However, obtaining these directions for navigation may involve the use of multiple computing applications and an excessive number of steps that may prove burdensome to some users as well as being resource inefficient. Accordingly, there exists a demand for a more streamlined way to obtain directions for navigation.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of navigation. The computer-implemented method can include receiving, by a computing system comprising one or more processors, a navigation request from a user. The computer-implemented method can include determining, by the computing system, whether the navigation request is associated with a user contact of the user. The computer-implemented method can include, in response to the navigation request being associated with the user contact, generating, by the computing device, a location sharing request. The location sharing request comprises a request for location data comprising information associated with one or more locations associated with the user contact. The computer-implemented method can include sending, by the computing system, the location sharing request to one or more remote computing systems associated with the user contact. Furthermore, the computer-implemented method can include, in response to receiving the location data from the one or more remote computing systems, generating, by the computing system, output comprising one or more indications associated with navigation by the user to at least one of the one or more locations associated with the user contact.

Another example aspect of the present disclosure is directed to one or more tangible computer-readable media (which may or may not be non-transitory) storing computer-readable instructions that when executed by one or more processors cause the one or more processors to perform operations. The operations can include accessing, by a computing system comprising one or more processors, navigation data comprising information associated with a navigation request from a user. The operations can include determining, by the computing system, based at least in part on the navigation data, whether the navigation request is associated with a user contact of the user. The operations can include, in response to the navigation request being associated with the user contact, generating, by the computing device, a location sharing request. The location sharing request comprises a request for location data comprising information associated with one or more locations associated with the user contact. The operations can include sending, by the computing system, the location sharing request to one or more remote computing systems associated with the user contact. Furthermore, the operations can include, in response to receiving the location data from the one or more remote computing systems, generating, by the computing system, output comprising one or more indications associated with navigation by the user to at least one of the one or more locations associated with the user contact.

Another example aspect of the present disclosure is directed to a computing system comprising: one or more processors; one or more non-transitory computer-readable media storing instructions that when executed by the one or more processors cause the one or more processors to perform operations. The operations can include accessing, by a computing system comprising one or more processors, navigation data comprising information associated with a navigation request from a user. The operations can include determining, by the computing system, based at least in part on the navigation data, whether the navigation request is associated with a user contact of the user. The operations can include, in response to the navigation request being associated with the user contact, generating, by the computing device, a location sharing request. The location sharing request comprises a request for location data comprising information associated with one or more locations associated with the user contact. The operations can include sending, by the computing system, the location sharing request to one or more remote computing systems associated with the user contact. Furthermore, the operations can include, in response to receiving the location data from the one or more remote computing systems, generating, by the computing system, output comprising one or more indications associated with navigation by the user to at least one of the one or more locations associated with the user contact.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example of a computing system that performs operations associated with navigation according to example embodiments of the present disclosure.

FIG. 1B depicts a block diagram of an example of a computing device that performs operations associated with navigation according to example embodiments of the present disclosure.

FIG. 1C depicts a block diagram of an example of a computing device that performs operations associated with navigation according to example embodiments of the present disclosure.

FIG. 2 depicts a block diagram of an example of one or more machine-learned models according to example embodiments of the present disclosure.

FIG. 3 depicts an example of a user computing device according to example embodiments of the present disclosure.

FIG. 4 depicts an example of a navigation device according to example embodiments of the present disclosure.

FIG. 5 depicts an example of a navigation device according to example embodiments of the present disclosure.

FIG. 6 depicts a flow diagram of navigation route sharing according to example embodiments of the present disclosure.

FIG. 7 depicts a flow diagram of navigation route sharing according to example embodiments of the present disclosure.

FIG. 8 depicts a flow diagram of navigation route sharing according to example embodiments of the present disclosure.

FIG. 9 depicts a flow diagram of navigation route sharing according to example embodiments of the present disclosure.

Reference numerals that are repeated across plural figures are intended to identify the same features in various implementations.

### DETAILED DESCRIPTION

Example aspects of the present disclosure are directed to a computing system that can provide navigational assistance based on a user's navigation request. In particular, the disclosed technology can generate location sharing requests that are used to generate navigation indications that satisfy a user's navigation requests. Further, the disclosed technology can leverage the use of machine-learned models that can use natural language processing techniques to extract pertinent semantic information from navigation requests in order to determine a contact that can provide shared navigational information to the user.

For example, a user can use a navigation application to generate a navigation request (e.g., a search term entered provided to the navigation application) associated with location related to the user contact that the user intends to travel to. A computing system of the disclosed technology can then parse the navigation request and determine that the navigation request includes a user contact (e.g., the name of an individual listed in the user's contact data). Further, the computing system can send a location sharing request to the user contact to receive permission to navigate to the address. The location sharing request can be sent in advance of the user's navigation request (e.g., the computing system can proactively send location sharing requests to the contacts in the user's contact list) or at the time of the navigation request. Further, the user contacts can consent to the location sharing request by sharing their location data with the user in advance of the navigation request. The computing device can then generate output including navigation indications to route the user to the location associated with the navigation request.

As such, the disclosed technology allows for improved navigation by determining the semantic content of the user's navigation request and in particular whether a user contact was included in the navigation request. Furthermore, the disclosed technology allows the user to navigate to locations more efficiently by providing navigation indications that are based on current information (e.g., the current address of a user contact which may not yet have been updated on a publicly available computing system). The disclosed technology therefore handles navigation requests in a way that can lead to more efficient travel.

By way of example, the disclosed technology can use one or more devices operated by a user (e.g., a user operating a navigation device such as a smartphone, an in-vehicle computing system, and/or in-vehicle navigation system) to access the user's navigation request and use some combination of machine-learned models and/or heuristics to determine whether the navigation request is associated with a user contact. The computing system can then provide a route to the requested location via the user device. As such, the disclosed technology facilitates a user's interaction with a navigation system by providing accurate directions that do not require a very precise navigation request.

Accordingly, the disclosed technology can improve the user experience by providing the user with navigation indications that are based on a response to a location sharing request. Further, the disclosed technology can assist a user in more effectively and/or safely performing the technical task of navigation from one location to another by means of a continued and/or guided human-machine interaction process in which the disclosed technology generates navigation indications based on navigation requests and shared location requests from a user.

The disclosed technology can be implemented in a computing system (e.g., a navigation computing system) that is configured to access data, perform operations on the data (e.g., determine whether a navigation request from a user is associated with a user contact), and generate output including indications associated with navigation to one or more locations associated with the navigation request. Further, the computing system can leverage one or more machine-learned models that have been configured to parse the navigation request and generate a location sharing request based on the user contact associated with the navigation request. The computing system can be included in a vehicle (e.g., an in-vehicle navigation system) and/or as part of a system that includes a server computing device that receives data associated with a navigation request from the user that includes a starting location (e.g., a user's current location) and a destination from a user's client computing device (e.g., a smart phone), performs operations based on the data and sends output including navigation directions back to the client computing device. The client computing device can, for example, be configured to announce the user contact's address.

The computing system can access, receive, obtain, and/or retrieve navigation data. The navigation data can include information associated with a navigation request from a user. The navigation data can include information associated with one or more locations including a current location of a computing device. For example, the navigation data can include a latitude, longitude, and/or altitude associated with one or more locations including the current location and/or locations of user contacts. Further, the navigation data can include information associated with one or more maps of a geographic area that include the current location, a starting location (e.g., a starting location that is different from the current location), and/or the location of a user contact. In some embodiments, the navigation request can include a request to travel to a home location of the user contact, a request to travel to a business location of the user contact, and/or a request for one or more shared locations of the user contact.

The navigation request can be based at least in part on one or more inputs of a user to a user interface. The one or more inputs can include one or more tactile inputs (e.g., a user touching a user interface that is displayed on the touchscreen display of a computing device) and/or one or more verbal inputs (e.g., the user speaking the name of the location associated with the user contact). In some embodiments, the disclosed technology can be implemented on a computing device that operates one or more navigation applications, one or more map applications, and/or one or more search applications, that can be used to input the navigation request of a user.

The computing system can determine whether the navigation request is associated with a user contact of the user. For example, the computing system can search navigation data that includes one or more user contacts and can determine that the navigation request is associated with a user contact if the navigation request matches at least one of the one or more user contacts. By way of further example, the computing system can parse the words in a navigation request to determine whether the navigation request includes some combination of words that is associated with a user contact (e.g., the personal name of a user contact).

In some embodiments, the navigation data can include and/or be associated with contact data. The navigation data and/or contact data can include information associated with one or more locations of the one or more user contacts. For example, the contact data can include one or more addresses and/or one or more tagged locations associated with the one or more user contacts. Further, the contact data can include a unique location associated with a user contact (e.g., a user contact's sole home and/or sole place of business) and/or location information including an address; latitude, longitude, and/or altitude; and/or favorite locations of the user contact. Furthermore, the contact data can include information associated with the one or more contacts associated with the user and/or one or more shared locations provided by a portion of the one or more contacts. In some embodiments, the one or more contacts can be based at least in part on contact data associated with a telephone application, an e-mail application, and/or a text-messaging application.

In some embodiments, the computing system can access contact data that includes information associated with the one or more contacts associated with the user and one or more shared locations provided by a portion of the one or more contacts. Further, the one or more shared locations can include one or more previously visited locations of the one or more contacts that the one or more contacts consented to share with the user. For example, the computing system can access the contact data stored in a remote computing device. The contact data can include locations previously visited by the user contact including the latitude, longitude, and/or altitude of the respective locations.

Further, the computing system can determine that the navigation request is associated with the user contact of the user if the navigation request is associated with any of the one or more shared locations. For example, if the computing system finds a shared location (e.g., a favorite restaurant of a user contact) the computing system can determine that the navigation request is associated with the associated user contact.

In some embodiments, the computing system can store a portion of the location data in the contact data and/or the navigation data. For example, when the location data is sent to a user's computing device in response to a location sharing request, the location data can be stored as part of the contact data and/or the navigation data. In this way, previously received location data can be stored for future use.

In some embodiments, the determination of whether the navigation is associated with a user contact is based at least in part on the use and/or application of one or more machine-learned models that are configured and/or trained to determine whether the navigation request is associated with the user contact based at least in part on an input comprising the navigation request. For example, the one or more machine-learned models can be configured to determine whether the navigation request includes a user contact based at least in part on training data including a list of one or more user contacts that include user contact names and associated information (e.g., addresses of user contacts).

Further, the one or more machine-learned models can be configured and/or trained based at least in part on one or more navigation requests provided by a specific user. In this way the accuracy of the one or more machine-learned models can improve over time and become better configured to suit the unique requirements of a particular user. For example, the one or more machine-learned models can be configured and/or trained to learn the particular types of navigation requests that a user provides.

In some embodiments, the one or more machine-learned models can be configured to determine whether the navigation request is associated with a user contact based at least in part on an application of one or more natural language processing techniques. For example, the one or more machine-learned models can be configured and/or trained to determine the semantic content (e.g., a combination of a user contact and a related location) that are included in navigation requests based on spoken language inputs that may not precisely match the user contact location and/or user contact (e.g., a user contact by the name of “JAMES” may be referred to in the navigation request as “JIMMY”). Further, in some embodiments, the input to the machine-learned models can include one or more verbal inputs associated with the navigation request. Further, the one or more machine-learned models are configured to determine whether the navigation request is associated with a user contact based at least in part on an application of the one or more natural language processing techniques to the one or more aural inputs (e.g., a navigation request spoken by the user).

In some embodiments, the computing system determining whether the navigation request is associated with a user contact can include determining whether the navigation request is associated with a plurality of user contacts. For example, the computing system can determine whether the navigation request is associated with more than one user contact that includes the same name (e.g., the user has multiple user contacts with the same name).

Further, determining whether the navigation request is associated with a user contact can include generating a query comprising a request for the user to select a single user contact from the plurality of user contacts. The user contact can be based at least in part on the single user contact. For example, the computing system can generate a query via a user interface (e.g., graphical user interface) requesting the user to select the single user contact from a list of similar user contacts. The selected user contact is then used as the basis for the location sharing request.

The computing system can generate a location sharing request. The location sharing request can be generated in response to the navigation request being associated with the user contact. The location sharing request can include a request for location data that can include information associated with one or more locations associated with the user contact. For example, the location sharing request can include the name and/or identity of the user and a request for information associated with the location included in the navigation request (e.g., an address or set of coordinates). Further, the location sharing request can include information associated with whether the user is authorized to access and/or receive location data from the user contact. In some embodiments, the location data can include an address of the contact, a set of coordinates associated with the contact, and/or one or more directions associated with a location of the contact.

In some embodiments, sending the location sharing request can be contingent on the user confirming that the user contact is associated with the navigation request. For example, the computing system may only send the location sharing request if the user has confirmed that the user name provided to the user is associated with the navigation request.

The computing system can send the location sharing request to one or more remote computing systems associated with the user contact. For example, the computing system can send a location sharing request via text message to the personal computing device (e.g., smartphone) of the user contact. By way of further example, the location sharing request can be sent to a server computing device that stores location data for the user contact and provides location data to location sharing requests that are authorized by the respective user contact (e.g., authorized users on a share location data list). Any of the one or more locations can be associated with the user contact. For example, the one or more locations can include a home address of the user contact, a business address of the user contact, and/or shared locations (e.g., favorite places) of the user contact.

The computing system can generate output. The output can be generated in response to receiving the location data from any of the one or more remote computing systems. The output can include one or more indications associated with navigation by the user to at least one of the one or more locations associated with the user contact. For example, if the navigation request is associated with a user contact (e.g., the user contact's home is included in the navigation request) the output can include the indication “GENERATE A ROUTE TO THE USER CONTACT'S HOME.” Further, the output can include the current location of the user and/or one or more routes from the current location of the user's computing system and/or the user to the one or more locations associated with the user contact. For example, one or more routes from the current location to the one or more locations can be determined by accessing the navigation data and determining one or more paths from the current location of the user to the one or more locations associated with the user contact.

In some embodiments, the one or more indications can include one or more visual indications. Further, the one or more visual indications can include a map of a geographic area including a current location of the user and at least one of the one or more locations. Further, the map of the geographic area can be displayed on a user interface that is configured to allow the user to confirm a route to a location associated with the user contact.

The one or more indications can include a route from a current location of the user to a destination associated with the user contact. Further, the route can be based at least in part on the one or more locations. For example, the computing system can generate one or more indications including one or more routes from a current location of the user to the location associated with the user contact. The one or more routes can be determined based at least in part on the navigation data. For example, one or more routes from the current location to the user contact location can be determined by accessing the navigation data and determining one or more streets that connect the current location and the user contact location. The computing system can then determine one or more indications to direct the user to the user selected location.

In some embodiments, the one or more machine-learned models can be configured and/or trained to receive/access input including one or more portions of the navigation request, perform one or more operations on the input and generate output including whether the navigation request is associated with a user contact and/or one or more locations associated with the user contact. For example, the input to the one or more machine-learned models can include the name of a user contact's location (e.g., “JOHN'S HOUSE”) which is the location of a colleague of the user extracted from the navigation data. The one or more machine-learned models can generate output including a location sharing request that is sent to the user contact and that requests the user contact's home location.

In some embodiments, the output can include a request for feedback from the user with respect to whether the one or more locations associated with the user contact were in accordance with the navigation request. For example, the computing system can generate one or more aural indications indicating “IS THE LOCATION SHARING REQUEST ACCURATE?” The computing system can access, receive, obtain, and/or retrieve the feedback from the user via one or more user interfaces of the computing system. For example, after generating output that includes one or more aural indications (e.g., synthetic speech generated via one or more speakers of the computing system) of the request for feedback and/or one or more visual indications (e.g., a textual request for feedback displayed on a display device of the computing system) of the request for feedback, the computing system can detect the user's feedback in the form of a user's tactile user interaction with a user interface of the computing system.

The computing system can perform one or more operations based at least in part on the feedback from the user. The one or more operations can include storing the location data and/or the navigation request if the one or more locations associated with the user contact were in accordance with the navigation request. For example, if the location data corresponds to the navigation request, the location data can be stored for future use.

In some embodiments, the one or more operations can include modifying one or more heuristics associated with determining whether the navigation request is associated with a user contact, and/or training one or more machine-learned models that are configured to determine whether the navigation request is associated with a user contact. For example, the parameters of one or more machine-learned models can be adjusted when a user contact is associated with a navigation request.

In some embodiments, the output can include one or more turn-by-turn directions for navigation by the user to at least one of the one or more locations associated with the user contact. For example, the computing system can generate one or more turn-by-turn instructions to the one or more locations that indicate how the user should proceed via one or more visual indications generated on a display device and/or one or more aural indications generated via an audio output device of a computing system.

The disclosed technology can include a computing system (e.g., a navigation computing system) that is configured to perform various operations associated with the generation of location sharing requests and navigation indications based on a user's navigation request. In some embodiments, the computing system can be associated with various computing systems and/or computing devices that access, use, send, receive, and/or generate location sharing requests to provide navigational locations for use in navigation by a user.

The computing system can include specialized hardware and/or software that enable the performance of one or more operations specific to the disclosed technology. The computing system can include one or more application specific integrated circuits that are configured to perform operations associated with the generation of location sharing requests and navigational indications to assist a user in the task of navigation.

The systems, methods, devices, apparatuses, and tangible computer-readable media (which may or may not be non-transitory) in the disclosed technology can provide a variety of technical effects and benefits including an improvement in navigation by facilitating the sharing of navigation information. In particular, the disclosed technology may assist a user (e.g. a user of a navigation device) in performing technical tasks by means of a continued and/or guided human-machine interaction process in which location data based partly on the generation of location sharing requests are provided to a user on the basis of the user's navigation request (e.g., the identity of a user contact extracted from the navigation request). Furthermore, the disclosed technology may also provide additional benefits including improved efficiency of resource usage, a reduction in adverse environmental impact, and improved safety.

The disclosed technology can improve the efficiency of resource consumption (e.g., a reduction in the amount of energy consumed by a computing system, the amount of network resources consumed, and/or the amount of fuel and electrical energy that are used by various devices or systems). In particular, by generating output including a location sharing request and basing navigation instructions on the location sharing request, the disclosed technology can provide more accurate navigation instructions that can reduce travel time and thereby reduce excessive energy use and the resulting pollution.

Additionally, the disclosed technology can also reduce the adverse environmental impacts associated with inefficient navigation. For example, by contacting the user contact associated with the navigation request or using previously provided information from the user contact, the user has access to navigation information that precisely addresses the navigation request. In these ways, the disclosed technology can provide the benefits of a reduction in the amount of pollution that is generated during travel. In addition, the technology can provide a reduction in computer processing and/or bandwidth utilization, for example because the computing system can direct the user along a travel route for a reduced amount of time as a result of the more precise navigation instructions.

Further, the disclosed technology can provide the technical effect of improving the efficiency with which navigational tasks are performed. For example, the computing system navigation can be continuously updated in response to responses from user contacts as well as user feedback regarding the accuracy of user contacts associated with location sharing requests generated for the user. For example, machine-learned models that are used as part of the process of generating navigation indications can be continuously trained and/or updated in response to a user's use of the navigation indications as well as in response to direct feedback from the user. This has the effect of reducing the time required to reach the target destination as the destination is more accurately described. In turn, this leads to a reduction in resource usage of the computer system and associated infrastructure.

As such, the disclosed technology may assist the user of a navigation device by more effectively performing a variety of tasks with the specific benefits of reduced resource consumption, reduced environmental impact, and improved navigational efficiency. Further, any of the specific benefits provided to users can be used to improve the effectiveness of a wide variety of devices and services including navigation devices and/or navigation applications. Accordingly, the improvements offered by the disclosed technology can result in tangible benefits to a variety of devices and/or systems including mechanical, electronic, and computing systems associated with navigation including location sharing requests.

With reference now to the Figures, example embodiments of the present disclosure will be discussed in further detail.

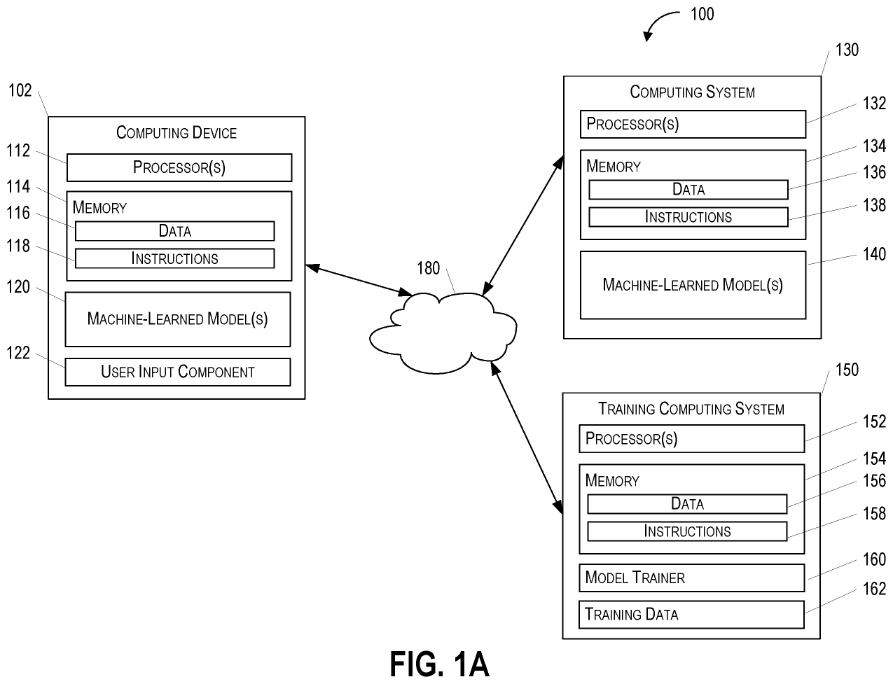

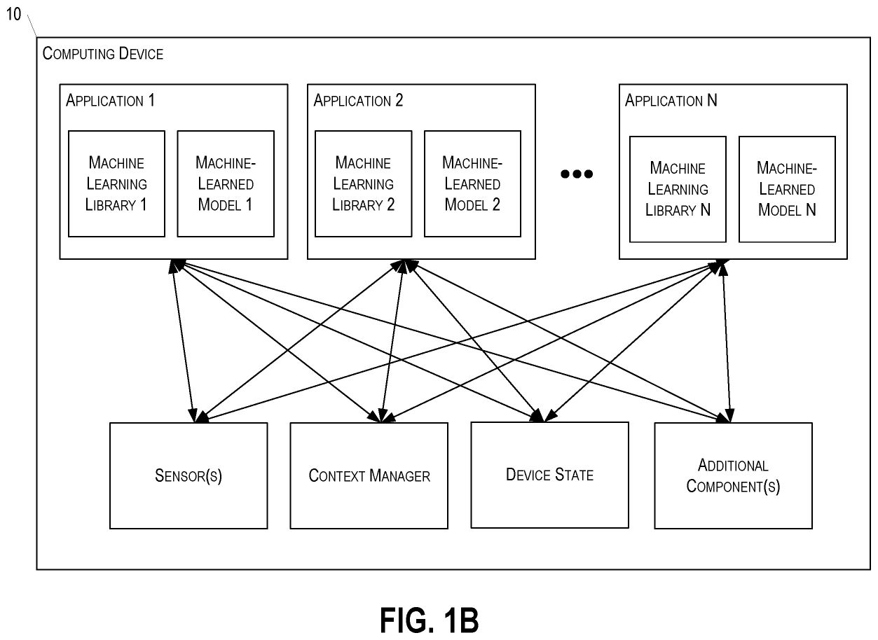

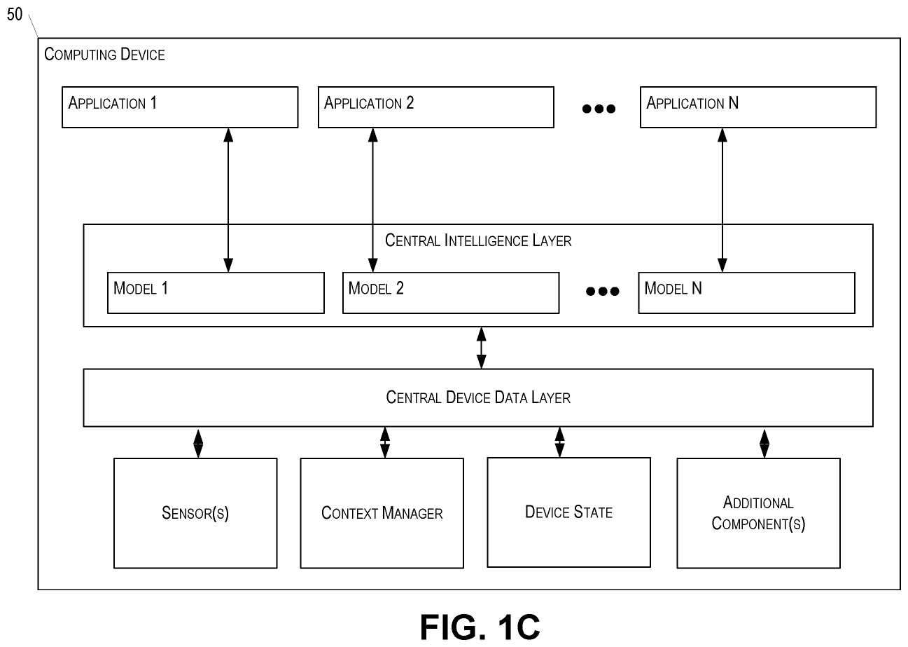

FIG. 1A depicts a block diagram of an example of a computing system 100 that performs operations associated with navigation according to example embodiments of the present disclosure. The system 100 includes a computing device 102, a computing system 130 (e.g., a server computing system 130), and a training computing system 150 that are communicatively coupled over a network 180.

The computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more computer-readable storage mediums (including non-transitory computer-readable storage mediums), such as RAM, ROM, EEPROM, EPROM, flash memory devices, magnetic disks, etc., and combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Examples of one or more machine-learned models 120 are discussed with reference to FIGS. 1A-9.

In some implementations, the one or more machine-learned models 120 can be received from the computing system 130 over network 180, stored in the memory 114, and then used or otherwise implemented by the one or more processors 112. In some implementations, the computing device 102 can implement multiple parallel instances of a single machine-learned model 120.

More particularly, the one or more machine-learned models 120 can be configured and/or trained to access contact data and/or navigation data including a navigation request from a user; determine whether the navigation request indicates a user contact; generate a location sharing request; and/or generate output including indications associated with navigation to one or more locations associated with the user contact.

Additionally, or alternatively, one or more machine-learned models 140 can be included in or otherwise stored and implemented by the computing system 130 that communicates with the computing device 102 according to a client-server relationship. For example, the one or more machine-learned models 140 can be implemented by the server computing system 130 as a portion of a web service (e.g., a navigation service that manages location sharing requests). Thus, one or more machine-learned models 120 can be stored and implemented at the computing device 102 and/or one or more machine-learned models 140 can be stored and implemented at the server computing system 130.

The computing device 102 can also include one or more of the user input component 122 that is configured to receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the computing system 130 to perform operations.

In some implementations, the computing system 130 includes or is otherwise implemented by one or more server computing devices. In instances in which the computing system 130 includes plural server computing devices, such server computing devices can operate according to sequential computing architectures, parallel computing architectures, or some combination thereof.

As described above, the computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1A-9.

The computing device 102 and/or the computing system 130 can train the one or more machine-learned models 120 and/or 140 via interaction with the training computing system 150 that is communicatively coupled over the network 180. The training computing system 150 can be separate from the computing system 130 or can be a portion of the computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the computing device 102 and/or the computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, one or more navigation requests including text based content and/or auditory content associated with various locations and times to depart and/or arrive at a location.

In some implementations, if the user has provided consent, the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can include image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text and/or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic output associated with the semantic content of a text or natural language input. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can include speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is of higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a navigation application, a mapping application, a routing application, an e-mail application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example of a computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a navigation application, a mapping application, a routing application, an e-mail application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

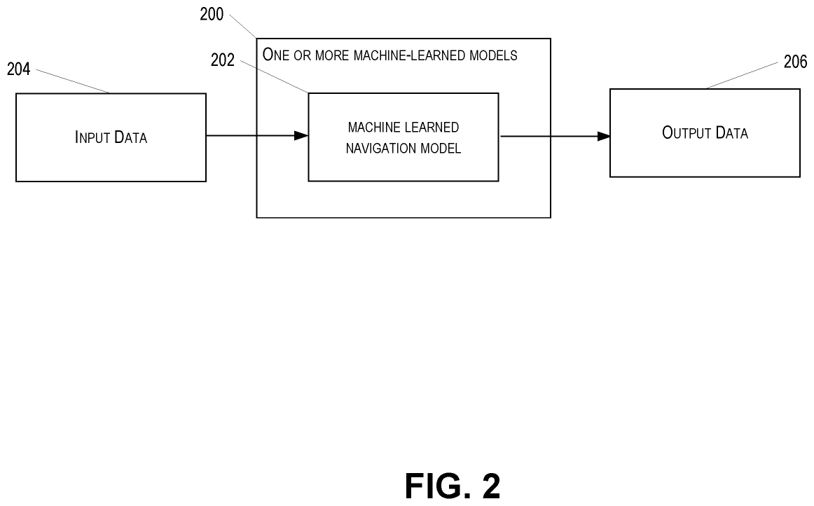

FIG. 2 depicts a block diagram of an example of one or more machine-learned models 200 according to example embodiments of the present disclosure. In some implementations, the one or more machine-learned models 200 are trained to access and/or receive a set of input data 204 descriptive of a navigation request (e.g., a navigation request for a user to travel to a location associate with a user contact) and, after performing one or more operations on the input data 204, generating output data 206 that includes information associated with one or more locations associated with the user contact. Thus, in some implementations, the one or more machine-learned models 200 can include a navigation machine-learned model 202 that is operable to generate output associated with indications of locations and times that allow a user to travel more effectively (e.g., shorter travel distance and/or duration).

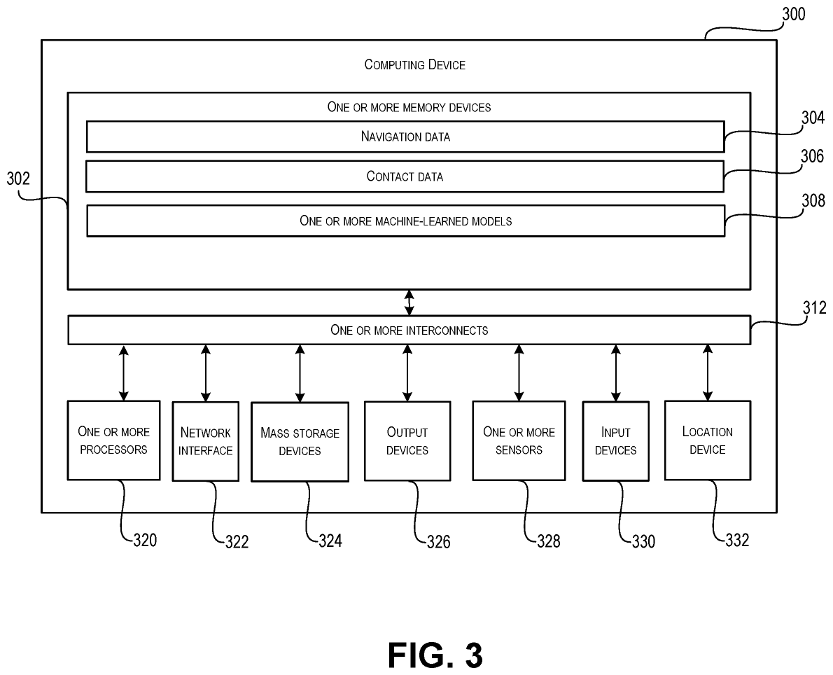

FIG. 3 depicts a diagram of an example computing device according to example embodiments of the present disclosure. A computing device 300 can include one or more attributes and/or capabilities of the computing device 102, the computing system 130, and/or the training computing system 150. Furthermore, the computing device 300 can perform one or more actions and/or operations including the one or more actions and/or operations performed by the computing device 102, the computing system 130, and/or the training computing system 150, which are depicted in FIG. 1A.

As shown in FIG. 3, the computing device 300 can include one or more memory devices 302, navigation data 304, contact data 306, one or more machine-learned models 308, one or more interconnects 312, one or more processors 320, a network interface 322, one or more mass storage devices 324, one or more output devices 326, one or more sensors 328, one or more input devices 330, and/or the location device 332.

The one or more memory devices 302 can store information and/or data (e.g., the navigation data 304, the contact data 306, and/or the one or more machine-learned models 308). Further, the one or more memory devices 302 can include one or more non-transitory computer-readable storage media, including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with generating one or more indications for navigation by a user.

The navigation data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the navigation data 304 can include information associated with one or more navigation requests, one or more locations, and/or one or more routes from a current location to a destination that can be implemented on the computing device 300. In some embodiments, the navigation data 304 can be received from one or more computing systems (e.g., the computing system 130 that is depicted in FIG. 1) which can include one or more computing systems that are remote (e.g., in another room, building, part of town, city, or nation) from the computing device 300.

The contact data 306 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the contact data 306 can include information associated with user contacts associated with a user (e.g., the locations of other users associated with the user) and that can be implemented on the computing device 300. In some embodiments, the contact data 306 can be received from one or more computing systems (e.g., the computing system 130 that is depicted in FIG. 1) which can include one or more computing systems that are remote from the computing device 300.

The one or more machine-learned models 308 (e.g., the one or more machine-learned models 120 and/or the one or more machine-learned models 140) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 308 can include information associated with accessing navigation data (that includes a navigation request) and/or contact data; determining whether the navigation request is associated with a user contact; generating a location sharing request; and generating output associated with user navigation to one or more locations associated with the user contact. In some embodiments, the one or more machine-learned models 308 can be received from one or more computing systems (e.g., the computing system 130 that is depicted in FIG. 1) which can include one or more computing systems that are remote from the computing device 300.

The one or more interconnects 312 can include one or more interconnects or buses that can be used to send and/or receive one or more signals (e.g., electronic signals) and/or data (e.g., the navigation data 304, the contact data 306, and/or the one or more machine-learned models 308) between components of the computing device 300, including the one or more memory devices 302, the one or more processors 320, the network interface 322, the one or more mass storage devices 324, the one or more output devices 326, the one or more sensors 328 (e.g., a sensor array), and/or the one or more input devices 330. The one or more interconnects 312 can be arranged or configured in different ways including as parallel or serial connections. Further the one or more interconnects 312 can include one or more internal buses to connect the internal components of the computing device 300; and one or more external buses used to connect the internal components of the computing device 300 to one or more external devices. By way of example, the one or more interconnects 312 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), and/or one or more graphics processing units (GPUs). Further, the one or more processors 320 can perform one or more actions and/or operations including one or more actions and/or operations associated with the navigation data 304, the contact data 306, and/or the one or more machine-learned models 308. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). The one or more mass storage devices 324 (e.g., a hard disk drive and/or a solid state drive) can be used to store data including the navigation data 304, the contact data 306, and/or the one or more machine-learned models 308. The one or more output devices 326 can include one or more display devices (e.g., LCD display, OLED display, Mini-LED display, microLED display, plasma display, and/or CRT display), one or more light sources (e.g., LEDs), one or more loudspeakers, and/or one or more haptic output devices (e.g., one or more devices that are configured to generate vibratory output).

The one or more input devices 330 can include one or more keyboards, one or more touch sensitive devices (e.g., a touch screen display), one or more buttons (e.g., ON/OFF buttons and/or YES/NO buttons), one or more microphones, and/or one or more cameras.

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the indications associated with navigation by the user. The one or more memory devices 302 can be used to operate various applications including a mobile operating system developed specifically for mobile devices. As such, the one or more memory devices 302 can store instructions that allow the software applications to access data including data associated with the generation of indications for navigation by a user. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position.

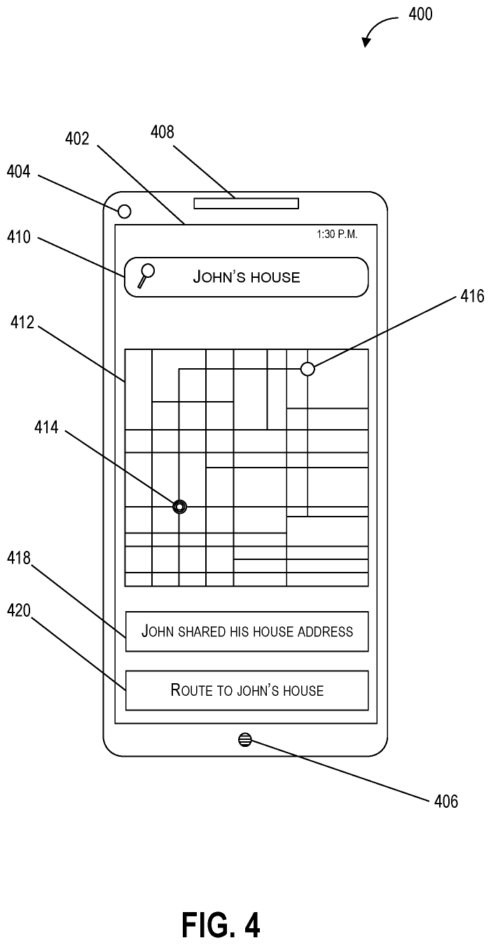

FIG. 4 depicts an example of a navigation device according to example embodiments of the present disclosure. A computing device 400 can include one or more attributes and/or capabilities of the computing device 102, the computing system 130, the training computing system 150, and/or the computing device 300. Furthermore, the computing device 400 can perform one or more actions and/or operations including the one or more actions and/or operations performed by the computing device 102, the computing system 130, the training computing system 150, and/or the computing device 300.

As shown in FIG. 4, the computing device 400 includes a display component 402, an imaging component 404, an audio input component 406, an audio output component 408, an interface element 410, an interface element 412, an interface element 414, an interface element 416, an interface element 418, and an interface element 420.

The computing device 400 can be configured to perform one or more operations including accessing, processing, sending, receiving, and/or generating data including navigation data and/or contact data, any of which can include information associated with one or more locations, one or more maps of one or more geographic areas, and/or one or more contacts of a user (e.g., contacts associated with a computing application that can include the addresses and/or locations associated with a user contact). Further, the computing device 400 can receive one or more inputs including one or more user inputs from a user of the computing device 400. For example, a user can provide a location to which the user intends to travel by entering the name of a destination associated with a user contact via the interface element 410 which is displayed on the display component 402 that also shows the interface element 414 which indicates the current location of the computing device 400.

In this example, a user has opened a navigation application on the computing device 400 and is searching for the location of his colleague. The user has entered the search term “JOHNS HOUSE” in the interface element 410 which is used to receive user inputs associated with a search for a location associated with a user contact in a geographic area and is configured to receive one or more inputs including touch inputs (e.g., the user touching characters on a pop-up keyboard and spelling out the name of a user contact associated with a location to which the user intends to travel) and/or aural inputs (e.g., the user speaking the search term including the user contact).

The computing device 400 can then send a location sharing request to the user contact (“JOHN”) to determine the location of “JOHN'S HOUSE” which can be represented on the interface element 412 (e.g., a map of the geographic area within a predetermined distance of the computing device 400) which also includes the interface element 414 that indicates the current location of the computing device 400.

Furthermore, in some embodiments, the computing device 400 can generate output including a combination of one or more indications that include one or more locations associated with the user contact. For example, the computing device 400 can generate output including the location of the user contact as indicated by the interface element 416.

The computing device 400 can generate the interface element 418 which indicates that the user contact “JOHN SHARED HIS HOUSE ADDRESS.” Additionally, the computing device can generate the interface element 420 which indicates “ROUTE TO JOHN'S HOUSE.” If the user activates the interface element 420 (e.g., by touching the interface element 420), the computing device can provide navigation indications including a route to the location of the user contact (e.g., “JOHN'S HOUSE”).

In some embodiments, the computing device 400 can use the audio output component 408 to generate an audio output (e.g., a synthetic voice) that provides output including one or more aural indications of the content associated with the interface element 418 and/or the interface element 420. For example, the audio output component 408 can generate one or more aural indications indicating “JOHN SHARED HIS HOUSE ADDRESS” in the interface element 418. Further, the user can provide their response to the computing device 400 via one or more inputs to the audio input component 406 (e.g., a microphone) which can be configured to detect a user's voice. The computing device 400 can then perform one or more voice recognition operations to determine the user's chosen course of action based on what the user says in response to the one or more aural indications.

In some embodiments, the computing device 400 can determine a user's chosen course of action based at least in part on use of the imaging component 404 (e.g., a camera). For example, the audio output component 408 can generate one or more aural indications indicating “NOD TO GENERATE A ROUTE TO JOHN'S HOUSE.” The user can then provide their response to the computing device 400 via one or more inputs to the imaging component 404 (e.g., a camera) which can be configured to detect whether the user has nodded.

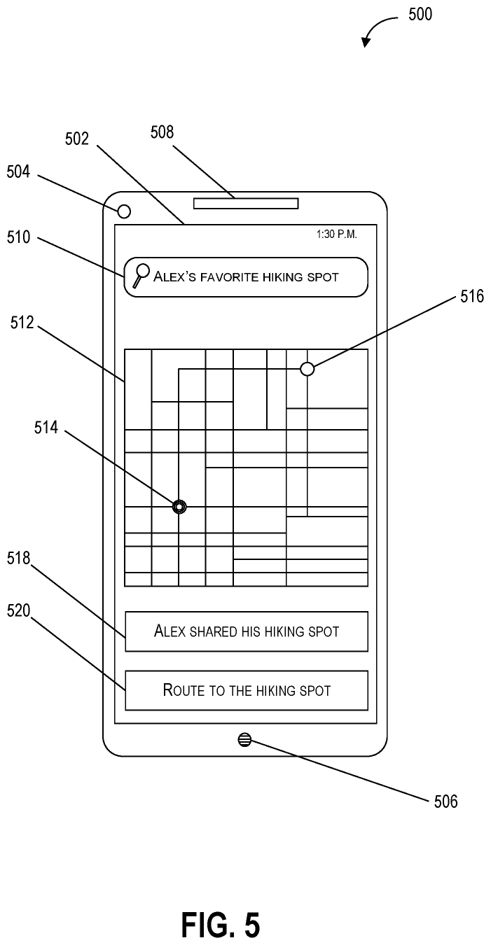

FIG. 5 depicts an example of a navigation device according to example embodiments of the present disclosure. A computing device 500 can include one or more attributes and/or capabilities of the computing device 102, the computing system 130, the training computing system 150, and/or the computing device 300. Furthermore, the computing device 500 can perform one or more actions and/or operations including the one or more actions and/or operations performed by the computing device 102, the computing system 130, the training computing system 150, and/or the computing device 300.

As shown in FIG. 5, the computing device 500 includes a display component 502, an imaging component 504, an audio input component 506, an audio output component 508, an interface element 510, an interface element 512, an interface element 514, an interface element 516, an interface element 518, and an interface element 520.

The computing device 500 can be configured to perform one or more operations including accessing, processing, sending, receiving, and/or generating data including navigation data and/or contact data, any of which can include information associated with one or more locations, one or more maps of one or more geographic areas, and/or one or more contacts of a user (e.g., contacts associated with a computing application that can include the addresses and/or locations associated with a user contact). Further, the computing device 500 can receive one or more inputs including one or more user inputs from a user of the computing device 500. For example, a user can provide a location to which the user intends to travel by entering the name of a destination associated with a user contact via the interface element 510 which is displayed on the display component 502 that also shows the interface element 514 which indicates the current location of the computing device 500.

In this example, a user has opened a navigation application on the computing device 500 and is searching for the location of his colleague. The user has entered the search term “ALEX'S FAVORITE HIKING SPOT” in the interface element 510 which is used to receive user inputs associated with a search for a location associated with a user contact in a geographic area and is configured to receive one or more inputs including touch inputs (e.g., the user touching characters on a pop-up keyboard and spelling out the name of a user contact associated with a location to which the user intends to travel) and/or aural inputs (e.g., the user speaking the search term including the user contact).

The computing device 500 can then send a location sharing request to the user contact (“ALEX”) to determine the location of “ALEX'S FAVORITE HIKING SPOT” which can be represented on the interface element 512 (e.g., a map of the geographic area within a predetermined distance of the computing device 500) which also includes the interface element 514 that indicates the current location of the computing device 500. In this example, the user contact (“ALEX”) can be associated with location data that includes favorite locations of the user (e.g., favorite restaurants and/or locations of frequently visited attractions) including the user's favorite hiking spot.

Furthermore, in some embodiments, the computing device 500 can generate output including a combination of one or more indications that include one or more locations associated with the user contact. For example, the computing device 500 can generate output including the location of the user contact as indicated by the interface element 516.

The computing device 500 can generate the interface element 518 which indicates that the user contact “ALEX SHARED HIS HIKING SPOT.” Additionally, the computing device can generate the interface element 520 which indicates “ROUTE TO THE HIKING SPOT.” If the user activates the interface element 520 (e.g., by touching the interface element 520), the computing device can provide navigation indications including a route to the location of the user contact (e.g., “ALEX'S FAVORITE HIKING SPOT”).

In some embodiments, the computing device 500 can use the audio output component 508 to generate an audio output (e.g., a synthetic voice) that provides output including one or more aural indications of the content associated with the interface element 518 and/or the interface element 520. For example, the audio output component 508 can generate one or more aural indications indicating “ALEX SHARED HIS HIKING SPOT” in the interface element 518. Further, the user can provide their response to the computing device 500 via one or more inputs to the audio input component 506 (e.g., a microphone) which can be configured to detect a user's voice. The computing device 500 can then perform one or more voice recognition operations to determine the user's chosen course of action based on what the user says in response to the one or more aural indications.

In some embodiments, the computing device 500 can determine a user's chosen course of action based at least in part on use of the imaging component 504 (e.g., a camera). For example, the audio output component 508 can generate one or more aural indications indicating “NOD TO GENERATE A ROUTE TO THE HIKING SPOT.” The user can then provide their response to the computing device 500 via one or more inputs to the imaging component 504 (e.g., a camera) which can be configured to detect whether the user has nodded.

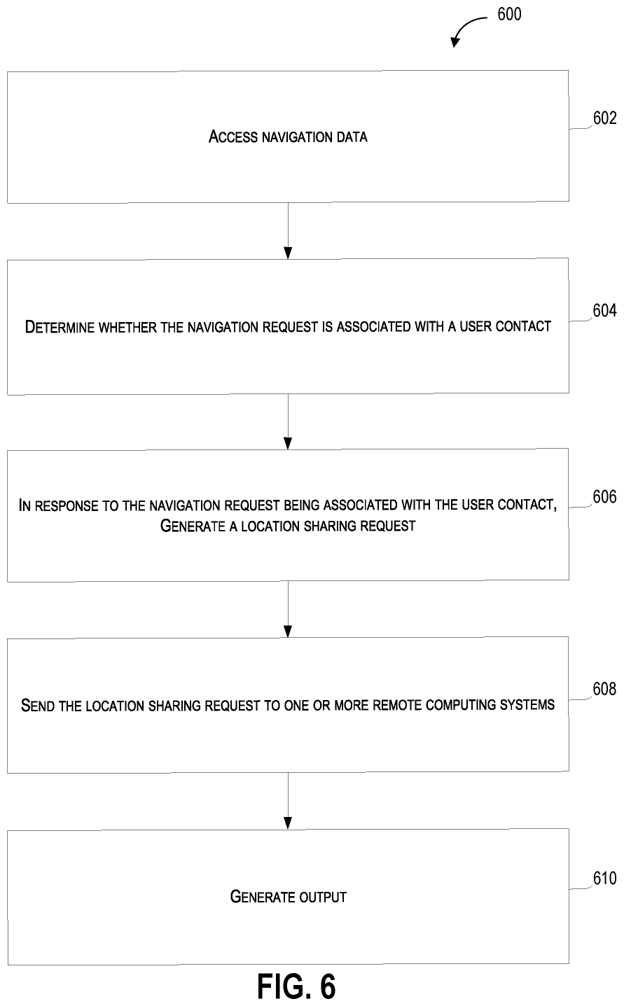

FIG. 6 depicts a flow diagram of navigation route sharing according to example embodiments of the present disclosure. One or more portions of the method 600 can be executed and/or implemented on one or more computing devices or computing systems including, for example, the computing device 102, the computing system 130, the training computing system 150, and/or the computing device 300. Further, one or more portions of the method 600 can be executed or implemented as an algorithm on the hardware devices or systems disclosed herein. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include accessing navigation data comprising information associated with a navigation request from a user. For example, the computing device 102 can access locally stored navigation data that includes information associated with the user's request for a location of a user contact. In some embodiments, one or more portions of the navigation data can be stored remotely (e.g., on the computing system 130) and the computing device 102 can access the one or more portions of navigation data based at least in part on the navigation request included in the navigation data.

At 604, the method 600 can include determining, based at least in part on the navigation data, whether the navigation request is associated with a user contact of the user. For example, the computing device 102 can use the navigation data as part of an input to one or more machine-learned models that are configured and/or trained to access the input, perform one or more operations on the input, and generate an output including a determination of whether the navigation request is associated with a user contact.

At 606, the method 600 can include, in response to the navigation request being associated with the user contact, generating a location sharing request. The location sharing request can include a request for location data comprising information associated with one or more locations associated with the user contact. For example, the computing device 102 can use the navigation data as part of an input to one or more machine-learned models that are configured and/or trained to access the input, perform one or more operations on the input, and generate an output including a location sharing request that will be sent to the user contact and/or a remote computing system that stores location data associated with the user contact.

At 608, the method 600 can include sending the location sharing request to one or more remote computing systems associated with the user contact. For example, the computing device 102 can send the location sharing request to a computing device (e.g., smartphone) associated with the user contact.

At 610, the method 600 can include, in response to receiving the location data from the one or more remote computing systems, generating output including one or more indications associated with navigation by the user to at least one of the one or more locations associated with the user contact. For example, the computing device 102 can include a display component that is used to display the one or more indications to at least one of the one or more locations associated with the user contact (e.g., the home of the user contact).

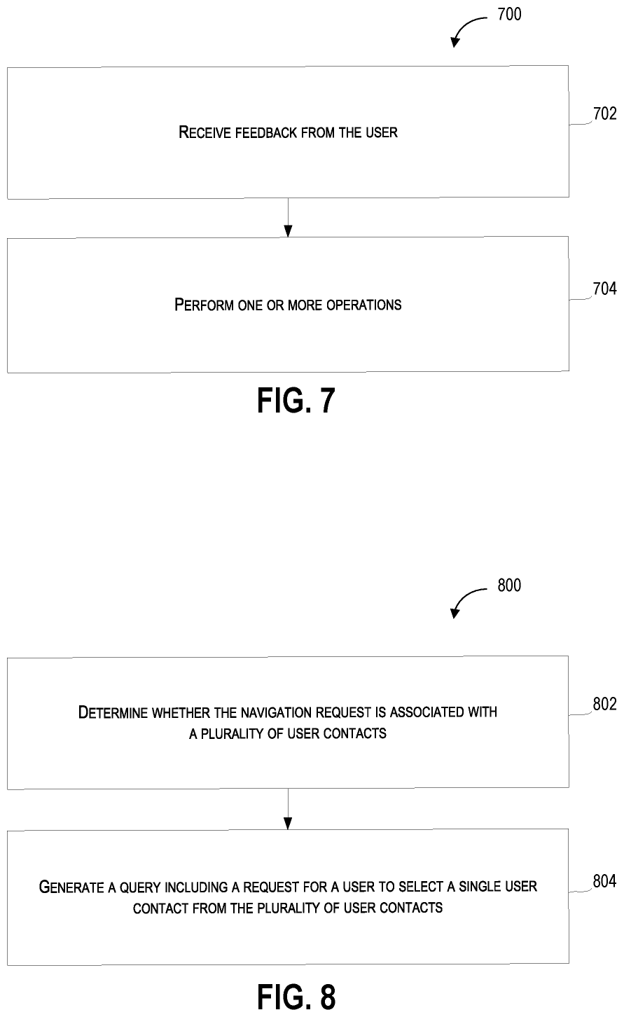

FIG. 7 depicts a flow diagram of navigation route sharing according to example embodiments of the present disclosure. One or more portions of the method 700 can be executed and/or implemented on one or more computing devices or computing systems including, for example, the computing device 102, the computing system 130, the training computing system 150, and/or the computing device 300. Further, one or more portions of the method 700 can be executed or implemented as an algorithm on the hardware devices or systems disclosed herein. In some embodiments, one or more portions of the method 700 can be performed as part of the method 600 that is depicted in FIG. 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include determining whether the navigation request is associated with a plurality of user contacts. For example, the computing device 102 can determine whether more than one user contact is associated with the navigation request.

At 704, the method 700 can include generating a query comprising a request for the user to select a single user contact from the plurality of user contacts. The user contact can be based at least in part on the single user contact. For example, the computing device 102 can request that the user select one of a plurality of user contact names that are similar. The user selected user contact can be determined to be the user contact associated with the navigation request.

FIG. 8 depicts a flow diagram of navigation route sharing according to example embodiments of the present disclosure. One or more portions of the method 800 can be executed and/or implemented on one or more computing devices or computing systems including, for example, the computing device 102, the computing system 130, the training computing system 150, and/or the computing device 300. Further, one or more portions of the method 800 can be executed or implemented as an algorithm on the hardware devices or systems disclosed herein. In some embodiments, one or more portions of the method 800 can be performed as part of the method 600 that is depicted in FIG. 6. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include receiving and/or accessing the feedback from the user. The feedback can be received and/or accessed via a user interface (e.g., a graphical user interface configured to receive tactile input from a user). The feedback from the user can be in response to output from the computing device 102 that requests feedback from the user with respect to whether the navigation data including the navigation request is associated with the user contact.

At 804, the method 800 can include performing one or more operations based at least in part on the feedback from the user. The one or more operations can include storing the location data and the navigation request if the one or more locations associated with the user contact were in accordance with the navigation request. For example, in response to the computing device 102 receiving feedback indicating that the user contact is associated with the navigation request, the computing device 102 can store a portion of the location data and/or the navigation request as part of the navigation data and/or contact data.

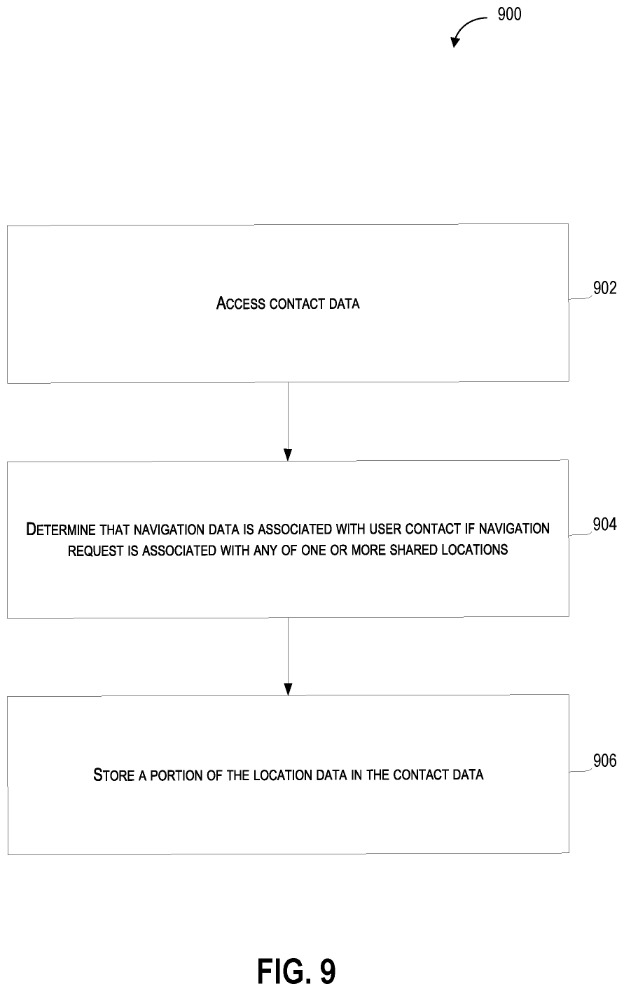

FIG. 9 depicts a flow diagram of navigation route sharing according to example embodiments of the present disclosure. One or more portions of the method 900 can be executed and/or implemented on one or more computing devices or computing systems including, for example, the computing device 102, the computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 600 that is depicted in FIG. 6. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include accessing contact data that can include information associated with the one or more contacts associated with the user and one or more shared locations provided by a portion of the one or more contacts. For example, the computing device 102 can access locally stored contact data that includes shared locations associated with the user contact that the user contact has consented to share with other users.

At 904, the method 900 can include determining, that the navigation request is associated with the user contact of the user if the navigation request is associated with any of the one or more shared locations. For example, the computing device 102 can determine that the navigation request is associated with the user contact if a shared location (e.g., a favorite location of the user contact that the user contact has shared with the user) of the user contact is associated with the navigation request.

At 906, the method 900 can include storing a portion of the location data in the contact data. For example, the computing device 102 can store the address and user contact name included in the location data as part of the contact data.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of navigation, the computer-implemented method comprising:
receiving, by a computing system comprising one or more processors, a navigation request from a user;
determining, by the computing system, whether the navigation request is associated with a user contact of the user;
in response to the navigation request being associated with the user contact, generating, by the computing device, a location sharing request, wherein the location sharing request comprises a request for location data comprising information associated with one or more locations associated with the user contact;
sending, by the computing system, the location sharing request to one or more remote computing systems associated with the user contact; and
in response to receiving the location data from the one or more remote computing systems, generating, by the computing system, output comprising one or more indications associated with navigation by the user to at least one of the one or more locations associated with the user contact.

2. The computer-implemented method of claim 1, wherein sending the location sharing request is contingent on the user confirming that the user contact is associated with the navigation request.

3. The computer-implemented method of claim 1, wherein the one or more indications comprise a route from a current location of the user to a destination associated with the user contact, and wherein the route is based at least in part on the one or more locations.

4. The computer-implemented method of claim 1, wherein the navigation request comprises a request to travel to a home location of the user contact, a request to travel to a business location of the user contact, or a request for one or more shared locations of the user contact.

5. The computer-implemented method of claim 1, wherein the output comprises a request for feedback from the user with respect to whether the one or more locations associated with the user contact were in accordance with the navigation request, and further comprising:
receiving, by the computing system, the feedback from the user; and
performing, by the computing system, one or more operations based at least in part on the feedback from the user, wherein the one or more operations comprise storing the location data and the navigation request if the one or more locations associated with the user contact were in accordance with the navigation request.

6. The computer-implemented method of claim 5, wherein the one or more operations comprise modifying one or more heuristics associated with determining whether the navigation request is associated with the user contact, or training one or more machine-learned models that are configured to determine whether the navigation request is associated with the user contact.

7. The computer-implemented method of claim 1, wherein the determining, by the computing system, whether the navigation request is associated with a user contact of the user comprises:
determining, by the computing system, whether the navigation request is associated with a plurality of user contacts; and
generating, by the computing system, a query comprising a request for the user to select a single user contact from the plurality of user contacts, wherein the user contact is based at least in part on the single user contact.

8. The computer-implemented method of claim 1, wherein the determining, by the computing system, whether the navigation request is associated with a user contact of the user comprises:
accessing, by the computing system, contact data comprising information associated with the one or more contacts associated with the user and one or more shared locations provided by a portion of the one or more contacts; and
determining, by the computing system, that the navigation request is associated with the user contact of the user if the navigation request is associated with any of the one or more shared locations.

9. The computer-implemented method of claim 8, further comprising:
storing, by the computing system, a portion of the location data in the contact data.

10. The computer-implemented method of claim 8, wherein the one or more shared locations comprise one or more previously visited locations of the one or more contacts that the one or more contacts consented to share with the user.

11. The computer-implemented method of claim 1, wherein whether the navigation request is associated with a user contact of the user is based at least in part on use of one or more machine-learned models configured to determine whether the navigation request is associated with a user contact based at least in part on an input comprising the navigation request.

12. The computer-implemented method of claim 11, wherein the input comprises one or more auditory inputs associated with the navigation request or one or more tactile inputs associated with the navigation request.

13. The computer-implemented method of claim 11, wherein the one or more machine-learned models are configured to determine whether the navigation request is associated with a user contact based at least in part on an application of one or more natural language processing techniques.

14. The computer-implemented method of claim 1, wherein the location data comprises an address of the contact, a set of coordinates associated with the contact, or one or more directions associated with a location of the contact.

15. One or more tangible computer-readable media storing computer-readable instructions that when executed by one or more processors cause the one of more processors to perform the method of claim 1.

16. The one or more tangible computer-readable media of claim 15, wherein the one or more indications comprise one or more visual indications, and wherein the one or more visual indications comprise a map of a geographic area comprising a current location of the user and at least one of the one or more locations.

17. The one or more tangible computer-readable media of claim 15, wherein the one or more contacts are based at least in part on contact data associated with a telephone application, an e-mail application, or a text-messaging application.

18. A computing system comprising:
one or more processors;
one or more computer-readable media storing instructions that when executed by the one or more processors cause the one or more processors to perform the method of claim 1.

19. The computing system of claim 18, wherein the output comprises one or more turn-by-turn directions for navigation by the user to at least one of the one or more locations associated with the user contact.

20. The computing system of claim 18, wherein the navigation request is based at least in part on one or more inputs of the user to a user interface, and wherein the one or more inputs comprise one or more tactile inputs or one or more verbal inputs.
